(19) United States
(12) Patent Application Publication
(10) Pub. No.: US 2002/0160918 A1
(43) Pub. Date: Oct. 31, 2002

(54) Phosphate ester-based surfactant adjuvants and compositions containing same

(75) Inventors: David C. Lewis, Austin, TX (US); Howard M. Stridde, Georgetown, TX (US)

Correspondence Address: Russell R. Stolle, Huntsman Corporation, P.O. Box 15730, Austin, TX, 78761, US

(73) Assignee: Huntsman Petrochemical Corporation, Austin, TX

(21) Appl. No.: 10/121,319

(22) Filed: Apr. 12, 2002

Related U.S. Application Data
(63) Continuation-in-part of application No. 09/900,358, filed on Jul. 6, 2001.
Application No. 09/900,358 is a continuation-in-part of application No. 09/641,225, filed on Aug. 17, 2000, now abandoned.
(60) Provisional application No. 60/149,542, filed on Aug. 18, 1999.
(60) Provisional application No. 60/149,553, filed on Aug. 18, 1999.

(51) Int. Cl. A01N 25/04; A01N 25/16

(52) U.S. Cl. 504/363; 504/365

(57) ABSTRACT

Disclosed herein are surfactants useful for improving the bioefficacy of herbicides. A surfactant according to the invention may comprise: (i) phosphate monoesters of tallow amine ethoxylates, alone or in combination with phosphate diesters of tallow amine ethoxylates, or (ii) alkoxylated phosphate monoesters of tallow amine ethoxylates, alone or in combination with alkoxylated phosphate diesters of tallow amine ethoxylates. The present invention also provides for herbicide compositions that contain the surfactants of the present invention. The herbicide compositions comprise a herbicidal active ingredient, a surfactant of the present invention, and optionally, one or more formulation aids. The herbicide compositions of the present invention unexpectedly have a reduced tendency to cause eye and skin irritation. The present invention additionally provides for a method of controlling unwanted weeds or vegetation using the herbicide compositions of the present invention.

### CROSS REFERENCE TO RELATED APPLICATIONS

This application is a continuation-in-part of application Ser. No. 09/900,358 which was filed Jul. 6, 2001 which was itself a continuation-in-part of application serial number 09/641,225 filed Aug. 17, 2000, currently still pending, and claims benefit of U.S. Provisional Applications No. 60/149,542 and 60/149,553, both filed on Aug. 18, 1999. The entire contents of all of these aforesaid Applications are herein incorporated by reference thereto.

### TECHNICAL FIELD

This invention relates to surfactants, and, more particularly, to phosphorous-bearing aminated surfactants that enhance the bioefficacy of herbicides, which surfactants are later degraded under normal environmental conditions to provide essential nutrients nitrogen and phosphorous to soil in surrounding terrain. Thus, surfactants according to the invention have a dual role, in that they not only enhance the bioefficacy of herbicides such as glyphosates, but serve as fertilizers as well.

### BACKGROUND OF THE INVENTION

Herbicide compositions are typically characterized according to the identity of the active ingredient and the mode by which the active ingredient causes vegetation necrosis. Regardless of the active ingredient, most herbicides cause vegetation necrosis by interfering with one or more vital biological processes essential to the vegetation's survival. Yet, before the active ingredient of a herbicide can interfere with such biological processes, the active ingredient must somehow be absorbed into the vegetation. Unfortunately, this absorption is often hindered by the chemical nature of the active herbicidal ingredient and its interaction on the leaf surface.

Accordingly, in addition to active ingredients, most herbicide compositions also comprise other components, commonly termed adjuvants, that enhance the absorption of the active ingredient and hence the overall performance of the herbicide composition.

One class of adjuvants that is frequently used is surfactants. Surfactants as a general class are useful in herbicide compositions because they tend to both enhance the absorbing properties of the active ingredient, as well as facilitate application of the herbicide.

Several patents of the prior art disclose various classes of surfactant adjuvants. One common class of surfactants includes derivatives of alkoxylated amines. For example, U.S. Pat. No. 5,683,958 discloses surfactants comprising tallow amine ethoxylates blended with a phosphate ester of an alkylphenol or alcohol ethoxylate; U.S. Pat. No. 5,798,310 discloses adjuvants comprising alkoxylated quaternary ammonium surfactants; U.S. Pat. No. 5,668,085 discloses glyphosate formulations comprising alkoxylated amine surfactants; and U.S. Pat. No. 5,118,444 discloses amine-oxide surfactants produced by oxidizing tertiary polyalkoxylated amine surfactants. All prior art patents set forth herein are herein incorporated by reference thereto.

However, the prior art appears to lack any reference to the use of phosphate esters or alkoxylated phosphate esters of tallow amine ethoxylates as suitable herbicide adjuvants. Surprisingly, it was discovered that phosphate esters and alkoxylated phosphate esters of tallow amine ethoxylates function to improve the bioefficacy of herbicide compositions containing such surfactants. Also, herbicide formulations comprising such phosphate esters or alkoxylated phosphate esters unexpectedly have a reduced tendency to cause eye and skin irritation.

Accordingly, the present invention is directed toward surfactant adjuvants comprising phosphate esters and alkoxylated phosphate esters of tallow amine ethoxylates, herbicide compositions comprising such surfactant adjuvants, and a method of controlling unwanted vegetation using such herbicide compositions.

### SUMMARY OF THE INVENTION

The present invention provides surfactants that improve the bioefficacy of herbicides. A surfactant according to the invention may comprise (i) phosphate monoesters of tallow amine ethoxylates, alone or in combination with phosphate diesters of tallow amine ethoxylates, or (ii) alkoxylated phosphate monoesters of tallow amine ethoxylates, alone or in combination with alkoxylated phosphate diesters of tallow amine ethoxylates. The monoesters (I) and the diesters (II) have the following general structure:

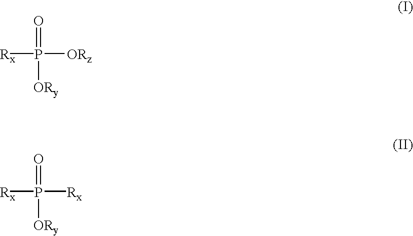

in which R_{y} and R_{z} are each independently hydrogen or R₆, where R₆ is a linear or branched chain alkyl having from about two to about six carbon atoms; and Rₓ has the following general structure:

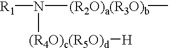

in which R₁ is a straight or branched chain alkyl or alkenyl group with from about six to about twenty carbon atoms; R₂, R₃, R₄, and R₅ are each independently straight-chain or branched alkyl groups with from about two to about six carbon atoms; a, b, c, and d each independently vary from zero to about twenty; and the sum of a+b+c+d varies from about five to about eighty, subject to the proviso that when a=1, b cannot be zero.

The present invention also provides for herbicide compositions that contain a surfactant according to the present invention. Such herbicide compositions comprise a herbicidally-active ingredient, a surfactant of the present invention, and optionally, one or more formulation aids. The herbicide compositions of the present invention unexpectedly have a reduced tendency to cause eye and skin irritation.

The present invention additionally provides for a method of controlling unwanted weeds or vegetation using a herbicide composition according to the present invention.

### DETAILED DESCRIPTION OF THE PREFERRED EMBODIMENT

The surfactants of the present invention may be used in conjunction with any number of herbicidal active ingredients. However, the use of the surfactants of the present invention with glyphosate is of particular interest because glyphosate is a widely-used herbicide.

Glyphosate, or N-phosphonomethylglycine, is a broad-spectrum herbicide that is useful on essentially all annual and perennial plants, including, grasses, broad-leaved weeds, and woody plants. Glyphosate promotes plant necrosis by inhibiting aromatic amino acid biosynthesis. By inhibiting aromatic amino acid synthesis, and thereby protein synthesis, glyphosate initially suppresses plant growth, which is soon followed by plant necrosis.

In its free acid form, glyphosate has a low water solubility. As such, water-based glyphosate compositions typically contain a water soluble salt of glyphosate, such as the isopropylamine salt. For example, many commercially available herbicides contain the water soluble mono-isopropylamine salt of glyphosate.

The surfactants of the present invention may be prepared by reacting either phosphorous pentoxide or polyphosphoric acid with one or more tallow amine ethoxylates. The tallow amine ethoxylate may comprise any number of commercially available tallow amine ethoxylates. Preferably, the tallow amine ethoxylates comprises SURFONIC® T5, SURFONIC® T15, SURFONIC® T20, or mixtures thereof (all commercially available from the Huntsman Corporation, Houston, Tex.

A typical preparation involves first heating one or more tallow amine ethoxylates to a temperature from about 50° C. to about 85° C. in a reaction vessel, and then gradually adding either phosphorous pentoxide or polyphosphoric acid. After all the phosphorous pentoxide or polyphosphoric acid has been added to the reaction vessel, the reaction components are then heated at a temperature from about 50° C. to about 130° C., under nitrogen, for at least 3 hours.

The resulting phosphate esters comprise monoesters (I), diesters (II), or mixtures thereof, with the following general structure:

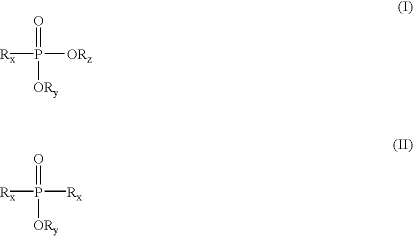

where R_{y} and R_{z} are hydrogen; and, Rₓ has the following general structure:

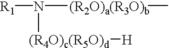

where R₁ is a straight or branched chain alkyl or alkenyl group with from about six to about twenty carbon atoms; R₂, R₃, R₄, and R₅ are each independently straight or branched chain alkyl groups with from about two to about six carbon atoms; a, b, c, and d each independently vary from about zero to about twenty; and the sum of a+b+c+d varies from about five to about eighty. In highly preferred embodiments, R₁ is a straight or branched chain alkyl or alkyl group with from about sixteen to about eighteen carbon atoms; R₂, R₃, R₄, and R₅ are each independently alkyl groups with from about two to about three carbon atoms; a+b varies from about fifteen to twenty; and c+d varies from about fifteen to twenty, subject to the proviso that when a=1, b cannot be zero.

The resulting phosphate ester surfactants may then be blended with one or more formulation aids before being combined with a herbicide. Such formulation aids may include alkoxylated amine surfactants, low molecular weight glycols, water, anti-freeze agents, dyes, thickening agents, anti-foaming agents, UV stabilizers, or mixtures thereof.

As a formulation aid, the alkoxylated amine surfactants function to consume any residual acidity from the phosphate ester preparation, and to raise the cloudpoint in the final herbicide formulation. Preferably, the alkoxylated amine surfactant formulation aids comprise lower tallow amine ethoxylates, meaning tallow amine ethoxylates with an ethylene oxide content equal to, or lower than, the ethylene oxide content of the phosphate esters of the present invention. Such alkoxylated amine surfactants may include, but are not limited to, SURFONIC® T5 or SURFONIC® T15.

As formulation aids, water and low molecular weight glycols help prevent gelling of the surfactants in the final herbicide formulation. The low molecular weight glycol formulation aids may comprise any lower molecular weight glycol, including, but not limited to, propylene glycol, ethylene glycol, or diethylene glycol.

The relative amount of formulation aids that should be blended with the phosphate ester surfactants of the present invention will depend on a variety of factors, including the degree of residual acidity from the phosphate ester preparation, the nature of the herbicide to be blended with the surfactant solution, the proposed mode of application of the final herbicide formulation, etc. If the phosphate ester surfactants of the present invention are to be incorporated into water-based glyphosate solutions, preferably, from about 26% to about 59% by mass of the blended surfactant solution should comprise the phosphate ester surfactants of the present invention, from about 21% to about 54% by mass of the blended surfactant solution should comprise an alkoxylated amine surfactant, from about 5% to about 10% by mass of the blended surfactant solution should comprise a low molecular weight glycol, and from about 10% to about 15% by mass the blended surfactant solution should comprise water.

Alternatively, instead of being blended with formulation aids, the phosphate ester surfactants of the present invention may be alkoxylated by reacting the phosphate esters with a lower molecular weight alkylene oxide, including, but not limited, to ethylene oxide, propylene oxide, and/or butylene oxide. A typical preparation involves first heating the phosphate ester in a reactor at a temperature from about 30° C. to about 80° C. Once the phosphate ester has been heated, one or more lower molecular weight alkylene oxides may be reacted with the phosphate ester until all the acidity is quenched (i.e. the pH is approximately 7.0), and a pressure rise is observed. The reactor may then be purged with nitrogen to eliminate any excess alkylene oxide. The resulting alkoxylated phosphate esters comprise alkoxylated monoesters (I), diesters (II), or mixtures thereof, with the following general structure:

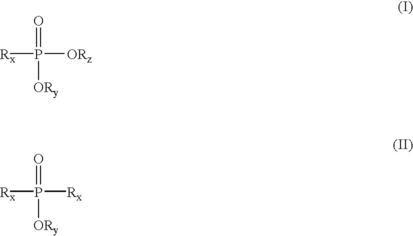

where R_{y} and R_{z} are R₆, where R₆ is a linear or branched chain alkyl with from two to six carbon atoms; and, Rₓ has the general structure:

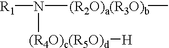

where R₁ is a straight-chain or branched alkyl or alkenyl group with from about six to about twenty carbon atoms; R₂, R₃, R₄, and R₅ are each independently straight-chain or branched alkyl groups with from about two to about six carbon atoms; a, b, c, and d may each independently be any integer in the range of zero to about twenty; and are selected so that the sum of a+b+c+d varies from about five to about eighty. In highly preferred embodiments, R₁ is a straight-chain or branched alkyl or alkenyl group with from about sixteen to about eighteen carbon atoms; R₂, R₃, R₄, and R₅ are each independently alkyl groups with from about two to about three carbon atoms; a+b varies from about fifteen to about twenty; and c+d varies from about fifteen to about twenty, subject to the proviso that when a is selected to equal 1, b is greater than zero.

One or more alkoxylated phosphate ester surfactant according to the invention may be blended with each other, water, or other formulation aids before being combined with a herbicidally-active material. Such other formulation aids include, without limitation, glycols, anti-freeze agents, dyes, thickening agents, anti-foaming agents, UV stabilizers, pH adjusting agents, or mixtures thereof. Preferably, the glycol may include, but is not limited to, polyethylene glycols, polypropylene glycols, or glycol ethers.

The relative amount of water or other formulation aids that should be blended with the alkoxylated phosphate ester surfactants of the present invention will depend on a variety of factors, including the nature of the herbicide to be blended with the surfactant solution, the proposed mode of application of the final herbicide formulation, the nature of the vegetation to be treated, etc. Preferably, less than about 90% by mass of the blended surfactant solution should comprise the alkoxylated phosphate ester surfactants of the present invention, and at least about 10% by mass of the blended surfactant solution should comprise water.

The surfactants of the present invention may then be blended with a herbicide. The relative amount of the surfactants of the present invention that should be blended with a herbicide will vary depending on a variety of factors, including the nature of the herbicide, the nature of the vegetation to be treated, the method of application, whether the herbicide is a water-based or a granular formulation, etc. Preferably, the resulting herbicide compositions of the present invention include a herbicidally-effective amount of a herbicidally-active ingredient, and a sufficient amount of a surfactant of the present invention to enhance the effectiveness of the herbicidal active ingredient. The term “herbicidally-effective amount” means the amount of herbicide necessary to cause plant necrosis when applied to foliage in conventional amounts.

The surfactants of the present invention may be blended with any number of commercially available herbicides, including, but not limited to glyphosate or a salt thereof. Preferably, in water-based glyphosate solutions, less than about 30% by volume of the herbicide composition should comprise the surfactant compositions of the present invention. The term “surfactant composition” means the surfactants of the present invention that have been blended with formulation aids.

The herbicide compositions of the present invention may be prepared as either liquid or solid compositions. Liquid compositions may include solutions ready for immediate application, aqueous concentrates intended to be diluted with water before application, or microencapsulated actives suspended in liquid media. Solid compositions may include, but are not limited to, water dispersible granules, water soluble granules, microencapsulated actives, free-flowing particulate compositions, or granular-based solids that have been compressed into tablets or briquettes of any desired size and shape. Optionally, solid compositions may include formulations where the herbicide composition is absorbed onto water soluble or water insoluble inert dry carriers, including, but not limited to, Magnesol® (commercially available from the Dallas Group of America, Inc., Whitehouse, N.J.).

Accordingly, the herbicide compositions of the present invention may be applied to vegetation as either a liquid or solid composition. Liquid herbicide compositions are typically sprayed on the vegetation to be treated, and typically comprise either liquid concentrates or dissolved or dispersed solid compositions. Liquid compositions may also be injected into, or painted on the truck portion of the vegetation to be treated. Solid granular compositions may be spread on or around the vegetation to be treated.

Herbicide formulations comprising the surfactant compositions of the present invention have an unexpected reduced tendency to cause eye and skin irritation. This is partly due to the fact that surfactant compositions according to the invention are useable at neutral pH levels. Because herbicides are often applied by humans, or in the vicinity of humans or animals, reduced eye irritation is a desirable feature in such compositions.

It is understood that variations may be made in the foregoing without departing from the scope of the invention. For example, although the surfactants of the present invention are primarily discussed as being incorporated into water-based herbicide compositions, it is understood that the surfactants of the present invention may also be incorporated into dry granular herbicide formulations. In addition, although the surfactants of the present invention are primarily discussed as being incorporated into glyphosate solutions, the surfactants of the present invention may be incorporated into any number of other herbicide formulations, including, but not limited to, macro and micro emulsions, suspension, suspension concentrates, and other liquid and solid formulations known to those skilled in the art, to increase the bioefficacy of such herbicides.

The following examples are illustrative of the present invention, and shall not be construed as delimitive of the scope of the invention in any way.

### PREPERATION OF THE PHOSPHATE ESTERS

### EXAMPLE 1a

769.5 grams of SURFONIC® T-15 were added to a reaction vessel, and heated to a temperature of 55° C., under nitrogen. Once the temperature reached 55° C., 130.5 grams of phosphorous pentoxide were gradually added to the reaction vessel. After all the phosphorous pentaoxide had been added to the reaction vessel, the mixture was heated at a temperature of 85° C., under nitrogen, for 3 hours.

The resulting phosphate ester was analyzed by 31p NMR. The results showed a relative mole ratio of 93.8% for the monoester, and a relative mole ratio of 6% for the diester.

### EXAMPLE 1b

837.0 grams of SURFONIC® T-15 were added to a reaction vessel, and the reaction vessel was heated to a temperature of 55° C., under nitrogen. Once the temperature reached 55° C., 63.0 grams of phosphorous pentaoxide were added to the reaction vessel. After all the phosphorous pentaoxide had been added to the reaction vessel, the mixture was heated at a temperature of 83° C., under nitrogen, for 3 hours.

### EXAMPLE 1c

868.5 grams of SURFONIC® T-15 were added to a reaction vessel, and the reaction vessel was heated to a temperature of 55° C., under nitrogen. Once the temperature reached 55° C., 31.5 grams of phosphorous pentaoxide were gradually added to the reaction vessel. After all the phosphorous pentaoxide was added to the reaction vessel, heating was continued, under nitrogen, for 3 hours. Heating was then discontinued, and the mixture was allowed to stand for approximately 12 hours. Then, the reaction mixture was heated to a temperature of 80° C., under nitrogen, for 2 hours.

PREPARATION OF PHOSPHATE ESTER SURFACTANT SOLUTION

### EXAMPLE 2

The phosphate esters produced in Examples 1a-1c were blended with formulation aids, in the following amounts (in grams):

| | Surfactant Solution | | |
|---|---|---|---|
| Component | A | B | C |
| phosphate ester from Example 1a | 211.36 | | |
| phosphate ester from Example 1b | | 352.00 | |
| phosphate ester from Example 1c | | | 472.00 |
| SURFONIC ® T5 | | 32.00 | 168.00 |
| SURFONIC ® T15 | 428.64 | 256.00 | |
| deionized water | 80.00 | 80.00 | 80.00 |
| diethylene glycol | 80.00 | 80.00 | 80.00 |

### Preparation of Glyphosate Solutions Containing the Phosphate Ester Surfactants of the Present Invention

### EXAMPLE 3

For each surfactant solution prepared in Example 2, a glyphosate solution was prepared that contained about 7.5, 15, and 30% vol. of the blended surfactant solution. Rodeo® was used as the source of glyphosate. (Rodeo® contains 648 g/L of the mono-isopropylamine salt of glyphosate.)

### BIOEFFICACY TESTING OF GLYPHOSATE SOLUTIONS CONTAINING PHOSPHATE ESTER SURFACTANTS OF THE PRESENT INVENTION

### EXAMPLE 4

An outside laboratory tested the bioefficacy of the glyphosate solutions prepared in Example 3 on morning glory and velvet leaf weeds. For comparison, the laboratory also tested the bioefficacy of a glyphosate solution that did not contain a surfactant, namely Rodeo®.

The bioefficacy testing was conducted in a greenhouse, using one foot by one foot plots, and a randomized complete block study design. The subject weeds were sprayed with each of the glyphosate solutions prepared in Example 3, under the following conditions:

| | |
|---|---|
| Application Pressure: | 40 psi |
| Nozzle Type: | Flat-fan |
| Nozzle Size: | 8002E |
| Boom Height, Unit: | 18 inches |
| Ground Speed, Unit: | 4 mph |
| Carrier: | water |
| Spray Volume: | 10 gpa |
| Propellant: | CO₂ |
| Rate/Unit: | 20 fluid ounce/acre |

The percent control or percent of plant injury was determined seven and fourteen days after treatment with the glyphosate solutions. For each glyphosate solution, four plots of weeds were tested. The results are expressed in terms of a mean for the four plots.

The results of the bioefficacy testing, completed on velvet leaf weeds, seven and fourteen days after treatment, are summarized in Table 1. The results are expressed in terms of percent control, where 0% represents no plant injury, and 100% represents complete plant injury. Seven and fourteen days after treatment with only glyphosate (i.e. Rodeo®, the percent control was 33% and 43%, respectively.

TABLE 1

| % surfactant | | Percent Control | | |
|---|---|---|---|---|
| solution | # days | A | B | C |
| 7.5% | 7 | 28 | 49 | 58 |
| | 14 | 46 | 73 | 75 |
| 15% | 7 | 48 | 50 | 60 |
| | 14 | 66 | 74 | 79 |
| 30% | 7 | 69 | 79 | 69 |
| | 14 | 89 | 92 | 89 |

The result of the bioefficacy testing completed on morning glory flowers, seven and fourteen days after treatment, are summarized in Table 2. The results are expressed in terms of percent control, where 0% represents no plant injury, and 100% represents complete plant injury. Seven and fourteen days after treatment with only glyphosate (i.e. Rodeo®), the present control and 24%, respectively.

TABLE 2

| % surfactant | | Percent Control | | |
|---|---|---|---|---|
| solution | # days | A | B | C |
| 7.5% | 7 | 59 | 66 | 68 |
| | 14 | 55 | 64 | 71 |
| 15% | 7 | 76 | 71 | 68 |
| | 14 | 76 | 79 | 74 |
| 30% | 7 | 89 | 78 | 76 |
| | 14 | 89 | 78 | 80 |

Referring to Tables 1 and 2, addition of the phosphate ester surfactants of the present invention of the glyphosate de compositions generally improves the herbicidal efficacy of glyphosathe formulations. In addition, certain phosphate ester surfactant composition are more effective at particular concentrations, and on particular types of weeds.

### PREPARATION OF THE ALKOXYLATED PHOSPHATE ESTERS

### EXAMPLE 5

431.53 grams of phosphate esters of SURFONIC® T15 were added to a pressure-sealed reactor, and heated to a temperature of about 70° C. Once the temperature reached 70° C., ethylene oxide was added to the reactor until all the acidity was quenched (i.e. the pH was approximately 7.0) and a pressure rise was observed. Then, the excess ethylene oxide was removed by purging the reactor with nitrogen.

### EXAMPLE 5b

416.04 grams of a phosphate ester of SURFONIC® T20 were added to a pressure-sealed reactor, and heated to a temperature of about 3 8° C. Once the temperature reached 38° C., ethylene oxide was added to the reactor, and the temperature was increased to 54° C. Ethylene oxide was added to the reactor until all the acidity was quenched (i. e. the pH was approximately 7.0), and a pressure rise was observed. Then, the excess ethylene oxide was removed by purging the reactor with nitrogen.

### EXAMPLE 5c

461.16 grams of a phosphate ester of SURFONIC® T5 were added to a pressure-sealed reactor, and heated to a temperature of about 73° C. Once the temperature reached 73° C., ethylene oxide was added to the reactor until all the acidity was quenched (i.e. the pH was approximately 7.0), and a pressure rise was observed. Then, the excess ethylene oxide was removed by purging the reactor with nitrogen.

### PREPARATION OF ALKOXYLATED PHOSPHATE ESTER SURFACTANT SOLUTION

### EXAMPLE 6

The alkoxylated phosphate esters produced in Examples 5a-5c were blended as follows (all amounts are in grams):

| | Surfactant Solution | |
|---|---|---|
| Component | A | B |
| alkoxylated phosphate ester from Example 5a | 144 | 0 |
| alkoxylated phosphate ester from Example 5b | 0 | 136 |
| alkoxylated phosphate ester from Example 5c | 16 | 24 |
| deionized water | 40 | 40 |

### PREPARATION OF GLYPHOSATE SOLUTION CONTAINING THE ALKOXYLATED PHOSPHATE ESTERS OF THE PRESENT INVENTION

### EXAMPLE 7

For each surfactant solution prepared in Example 6, a glyphosate solution was prepared that contained about 7.5, 15, and 30% vol. of the blended surfactant solution. Rodeo® was used as the source of glyphosate. (Rodeo® contains 648 g/L of the mono-isopropylamine salt of glyphosate.)

### BIOEFFICACY TESTING GLYPHOSATE SOLUTION CONTAINING THE ALKOXYLATED PHOSPHATE ESTERS OF THE PRESENT INVENTION

### EXAMPLE 8

The bioefficacy of the glyphosate solutions prepared in Example 7 on morning glory and velvet leaf weeds were tested under laboratory conditions. For comparison, the laboratory also tested the bioefficacy of a glyphosate solution that did not contain a surfactant, namely Rodeo®.

The bioefficacy testing was conducted in a greenhouse, using one foot by one foot plots, and a randomized complete block study design. The subject weeds were sprayed with each of the glyphosate solutions prepared in Example 7, under the following conditions:

| | |
|---|---|
| Application Pressure: | 40 psi |
| Nozzle Type: | flat-fan |
| Nozzle Size: | 8002E |
| Boom Height, Unit: | 18 inches |
| Ground Speed, Unit: | 4 mph |
| Carrier: | water |
| Spray Volume: | 10 gpa |
| Propellant: | air |
| Rate/Unit: | 18 fluid ounce/acre |

Twenty-one days after treatment, the green mass of each treated plant was weighed, and compared to the weight of the green mass of an untreated sample. From this comparison, the percent control or percent of plant injury was extrapolated. For each glyphosate solution, three plots of weeds were tested, and the results are expressed in terms of a mean for the three plots.

The results of the bioefficacy testing completed on velvet leaf and morning glory weeds, twenty-one days after treatment, are summarized in Table 3. The results are expressed in terms of percent control, where 0% represents no plant injury, and 100% represents complete plant injury.

TABLE 3

| | % control | % control |
|---|---|---|
| | velvet leaf | morning glory |
| Glyphosate solution without a | 51 | 50 |
| surfactant (Rodeo ®) | | |
| Glyphosate solution containing | 82 | 91 |
| 7.5% of surfactant solution A | | |
| Glyphosate solution containing | 92 | 98 |
| 15% of surfactant solution A | | |
| Glyphosate solution containing | 82 | 96 |
| 30% of surfactant solution A | | |
| Glyphosate solution containing | 68 | 93 |
| 7.5% of surfactant solution B | | |
| Glyphosate solution containing | 83 | 96 |
| 15% of surfactant solution B | | |
| Glyphosate solution containing | 83 | 96 |
| 30% of surfactant solution B | | |

Referring to Table 3, the addition of the alkoxylated phosphate ester surfactants of the present invention to glyphosate herbicide compositions improves the herbicidal efficacy of glyphosate formulations. Noticeably, particular alkoxylated phosphate ester surfactant compositions are more effective at particular concentrations, and on particular types of weeds.

Although illustrative embodiments have been shown and described, a wide range of modification, changes, and substitution is contemplated in the foregoing disclosure. In some instances, some features of the disclosed embodiments may be employed without a corresponding use of the other features. Accordingly, it is appropriate that the appended claims be construed broadly and in a manner consistent with the scope of the invention.

What is claimed is:

1. A herbicidal composition that comprises:
a. a herbicidally-effective amount of a herbicidally-active ingredient; and
b. an effective bioefficacy-enhancing amount of a surfactant component, wherein the surfactant component comprises: (i) phosphate monoesters of tallow amine ethoxylates, alone or in combination with phosphate diesters of tallow amine ethoxylates, or (ii) alkoxylated phosphate monoesters of tallow amine ethoxylates, alone or in combination with alkoxylated phosphate diesters of tallow amine ethoxylates, where the monoesters (I) and the diesters (II) have the general formula: 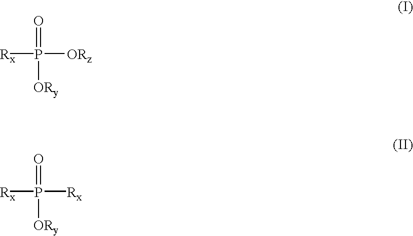
where R_{y} and R_{z} are each independently hydrogen or R₆, where R₆ is a linear or branched chain alkyl with from about two to about six carbon atoms; and, Rₓ has the general formula: 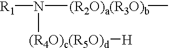
where R₁ is a straight-chain or branched alkyl or alkenyl group with from about six to about twenty carbon atoms; R₂, R₃, R₄, and R₅ are each independently straight or branched chain alkyl groups with from about two to about six carbon atoms; a, b, c, and d may each independently vary from zero to about twenty; and the sum of a+b+c+d varies from about five to about eighty, subject to the proviso that when a equals 1, b is not zero.

2. The composition of claim 1, wherein the herbicidally-active ingredient comprises glyphosate or a salt thereof.

3. The composition of claim 1, wherein R₁ is a straight or branched chain alkyl or alkenyl group with from about sixteen to about eighteen carbon atoms.

4. The composition of claim 1, wherein R₂, R₃, R₄, and R₅ are each independently alkyl groups with from about two to about three carbon atoms.

5. The composition of claim 1, wherein a+b varies from about fifteen to about twenty, and c+d varies from about fifteen to about twenty.

6. The composition of claim 1, wherein the surfactant component further comprises a formulation aid.

7. The composition of claim 6, wherein the formulation aid is selected from the group consisting of alkoxylated amine surfactants, low molecular weight glycols, water, or mixtures thereof.

8. The composition of claim 7, wherein the alkoxylated amine surfactant comprises a lower tallow amine ethoxylate.

9. The composition of claim 7, wherein the low molecular weight glycol comprises diethylene glycol.

10. The composition of claim 7, wherein from about 26% to about 59% by mass of the surfactant component comprises phosphate monoesters of tallow amine ethoxylates, alone, or in combination with phosphate diesters of tallow amine ethoxylates.

11. The composition of claim 10, wherein from about 21% to about 54% by mass of the surfactant component comprises the alkoxylated amine surfactant.

12. The composition of claim 11, wherein from about 5% to about 10% by mass of the surfactant component comprises the low molecular weight glycol.

13. The composition of claim 12, wherein from about 10% to about 15% by mass of the surfactant component comprises water.

14. The composition of claim 7, wherein less than about 90% by mass of the surfactant component comprises alkoxylated phosphate monoesters of tallow amine ethoxylates, alone, or in combination with alkoxylated phosphate diesters of tallow amine ethoxylates.

15. The composition of claim 14, wherein at least about 10% by mass of the surfactant component comprises water.

16. The composition of claim 13, wherein the herbicide composition has a reduced tendency to cause eye and skin irritation.

17. The composition of claim 15, wherein the herbicide composition has a reduced tendency to cause eye and skin irritation.

18. A surfactant for increasing the bioefficacy of a herbicide, wherein said surfactant comprises (i) phosphate monoesters of tallow amine ethoxylates, alone or in combination with phosphate diesters of tallow amine ethoxylates, or (ii) alkoxylated phosphate monoesters of tallow amine ethoxylates, alone or in combination with alkoxylated phosphate diesters of tallow amine ethoxylates, where the monoesters (I) and the diesters (II) have the general formulae: 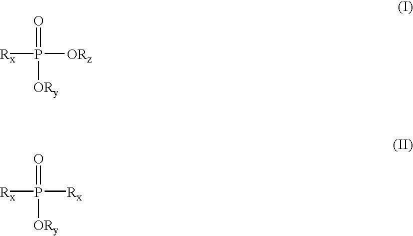
where R_{y} and R_{z} are each independently hydrogen or R₆, where R₆ is a linear or branched chain alkyl with from about two to about six carbon atoms; and, Rₓ has the general formula: 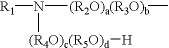
where R₁ is a straight-chain or branched alkyl or alkenyl group with from about six to about twenty carbon atoms; R₂, R₃, R₄, and R₅ are each independently straight-chain or branched alkyl groups with from about two to about six carbon atoms; a,b,c, and d each independently vary from zero to about twenty; and the sum of a+b+c+d varies from about five to about eighty, subject to the proviso that when a equals 1, b is not zero.

19. The surfactant of claim 18, wherein R₁ is a straight-chain or branched alkyl or alkenyl group with from about sixteen to about eighteen carbon atoms.

20. The surfactant of claim 18, wherein R₂, R₃, R₄, and R₅ are each independently alkyl groups with from about two to about three carbon atoms.

21. The surfactant of claim 18, wherein a+b varies from about fifteen to about twenty, and c+d varies from about fifteen to about twenty.

22. A surfactant composition for increasing the bioefficacy of a herbicide that comprises:
a. a surfactant comprising (i) phosphate monoesters of tallow amine ethoxylates, alone or in combination with phosphate diesters of tallow amine ethoxylates, or (ii) alkoxylated phosphate monoesters of tallow amine ethoxylates, alone or in combination with alkoxylated phosphate diesters of tallow amine ethoxylates,
where the monoesters (I) and the diesters (II) have the general formulae: 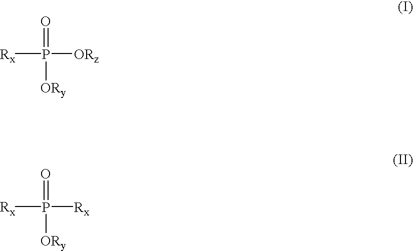
where R_{y} and R_{z} are each independently hydrogen or R₆, where R₆ is a linear or branched chain alkyl with from about two to about six carbon atoms; and, Rₓ has the general formula: 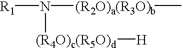
where R₁ is a straight-chain or branched alkyl or alkenyl group with from about six to about twenty carbon atoms; R₂, R₃, R₄, and R₅ are each independently straight-chain or branched alkyl groups with from about two to about six carbon atoms; a, b, c, and d each independently vary from zero to about twenty; and the sum of, a+b+c+d varies from about five to about eighty, subject to the proviso that when a equals 1, b is not zero; and
b. a formulation aid.

23. The composition of claim 22, wherein R₁ is a straight-chain or branched alkyl or alkenyl group with from about sixteen to about eighteen carbon atoms.

24. The composition of claim 22, wherein R₂, R₃, R₄, and R₅ are each independently alkyl groups with from about two to about three carbon atoms.

25. The composition of claim 22, wherein a+b varies from about fifteen to about twenty, and c+d varies from about fifteen to about twenty.

26. The composition of claim 22, wherein the formulation aid is selected from the group consisting of alkoxylated amine surfactants, low molecular weight glycols, water, or mixtures thereof.

27. The composition of claim 26, wherein the alkoxylated amine surfactant comprises a lower tallow amine ethoxylate.

28. The composition of claim 26, wherein the low molecular weight glycol comprises diethylene glycol.

29. The composition of claim 26, wherein from about 26% to about 59% by mass of the composition comprises phosphate monoesters of tallow amine ethoxylates, alone, or in combination with phosphate diesters of tallow amine ethoxylates.

30. The composition of claim 29, wherein from about 21% to about 54% by mass of the composition comprises the alkoxylated amine surfactant.

31. The composition of claim 30, wherein from about 5% to about 10% by mass of the composition comprises the low molecular weight glycol.

32. The composition of claim 31, wherein from about 10% to about 15% by mass of the composition comprises water.

33. The composition of claim 26, wherein less than about 90% by mass of the composition comprises alkoxylated phosphate monoesters of tallow amine ethoxylates, alone, or in combination with alkoxylated phosphate diesters of tallow amine ethoxylates.

34. The composition of claim 33, wherein at least about 10% by mass of the composition comprises water.

35. A herbicide composition that comprises:
a. a herbicidally-effective amount of glyphosate; and
b. an effective bioefficacy-enhancing amount of a surfactant component, wherein the surfactant component comprises: (i) phosphate monoesters of tallow amine ethoxylates, alone or in combination with phosphate diesters of tallow amine ethoxylates, or (ii) alkoxylated phosphate monoesters of tallow amine ethoxylates, alone or in combination with alkoxylated phosphate diesters of tallow amine ethoxylates, where the monoesters (I) and the diesters (II) have the general formulae: 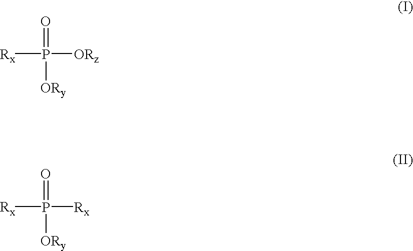
where R_{y} and R_{z} are each independently hydrogen or R₆, where R₆ is a straight-chain or branched alkyl with from about two to about six carbon atoms; and, Rₓ has the general formula: 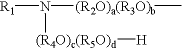
where R₁ is a straight or branched chain alkyl or alkyl group with from about six to about twenty carbon atoms; R₂, R₃, R₄, and R₅ are each independently straight or branched chain alkyl groups with from about two to about six carbon atoms; a, b, c, and d each independently vary from zero to about twenty; and the sum of a+b+c+d varies from about five to about eighty, subject to the proviso that when a equals 1, b is not zero.

36. The composition of claim 35, wherein R₁ is a straight-chain or branched alkyl or alkyl group with from about sixteen to about eighteen carbon atoms.

37. The composition of claim 35, wherein R₂, R₃, R₄, and R₅ are each independently alkyl groups with from about two to about three carbon atoms.

38. The composition of claim 35, wherein a+b varies from about fifteen to about twenty, and c+d varies from about fifteen to about twenty.

39. The composition of claim 35, wherein the surfactant component further comprises a formulation aid.

40. The composition of claim 39, wherein the formulation aid is selected from the group consisting of alkoxylated amine surfactants, low molecular weight glycols, water, and mixtures thereof.

41. The composition of claim 40, wherein the alkoxylated amine surfactant comprises a lower tallow amine ethoxylate.

42. The composition of claim 40, wherein the low molecular weight glycol comprises diethylene glycol.

43. The composition of claim 40, wherein from about 26% to about 59% by mass of the surfactant component comprises phosphate monoesters of tallow amine ethoxylates, alone, or in combination with phosphate diesters of tallow amine ethoxylates.

44. The composition of claim 43, wherein from about 21% to about 54% by mass of the surfactant component comprises the alkoxylated amine surfactant.

45. The composition of claim 44, wherein from about 5% to about 10% by mass of the surfactant component comprises the low molecular weight glycol.

46. The composition of claim 45, wherein from about 10% to about 15% by mass of the surfactant component comprises water.

47. The composition of claim 40, wherein less than about 90% by mass of the surfactant component comprises alkoxylated phosphate monoesters of tallow amine ethoxylates, alone, or in combination with alkoxylated phosphate diesters of tallow amine ethoxylates.

48. The composition of claim 47, wherein at least about 10% by mass of the surfactant component comprises water.

49. The composition of claim 48, wherein less than about 30% of the volume of the herbicide composition comprises the surfactant component.

50. The composition of claim 46, wherein less than about 30% of the volume of the herbicide composition comprises the surfactant component.

51. The composition of claim 46, wherein the herbicide composition has a reduced tendency to cause eye and skin irritation.

52. The composition of claim 48, wherein the herbicide composition has a reduced tendency to cause eye and skin irritation.

53. A method of killing or controlling weeds or unwanted vegetation comprising the step of applying a herbicidally-effective amount of the composition of claim 1 to the foliage or tissue of the weeds or unwanted vegetation.

54. A method of killing or controlling weeds or unwanted vegetation comprising the step of applying a herbicidally-effective amount of the composition of claim 35 to the foliage or tissue of the weeds or unwanted vegetation.
